(19) United States
(12) Patent Application Publication
(10) Pub. No.: US 2025/0123028 A1
(43) Pub. Date: Apr. 17, 2025

(54) Saddle Bracket Assembly

(71) Applicant: Gamechange Solar Corp., Norwalk, CT (US)

(72) Inventors: Andrew Barron Worden, Greenwich, CT (US); Jacob Grant, Springfield, MA (US); Zachary Cutting, Westminster, MA (US); David Dang, Norwalk, CT (US); Woo Kim, Little Neck, NY (US)

(73) Assignee: Gamechange Solar Corp., Norwalk, CT (US)

(21) Appl. No.: 18/917,028

(22) Filed: Oct. 16, 2024

Related U.S. Application Data
(60) Provisional application No. 63/544,255, filed on Oct. 16, 2023.

(51) Int. Cl. F24S 25/632; F24S 25/00; F24S 25/60

(52) U.S. Cl. CPC F24S 25/632; F24S 2025/6005; F24S 2025/804

(57) ABSTRACT

A saddle bracket assembly comprises a saddle bracket fastened to a saddle bracket support with a plurality of rivets. The saddle bracket web rests on a bracket support web with saddle bracket rivet holes coaxially aligned with an associated one of respective bracket support rivet holes and the coaxially aligned holes include one of a plurality of rivets to provide rivet joints that fasten the bracket support to the saddle bracket.

### CROSS REFERENCE TO RELATED APPLICATIONS

This application claims the benefit of U.S. Provisional Patent Application Ser. No. 63/544,255 filed Oct. 16, 2023, which is hereby incorporated by reference.

### BACKGROUND OF THE INVENTION

### 1. Technical Field

This disclosure relates generally to a solar panel installation and, more particularly, to apparatuses and assemblies for use in a solar panel installation.

### 2. Background Information

To fasten the solar panels to a tracker mount (e.g., a single axis tracker), various systems, mounting brackets, clamps and other fasteners exist. In utility scale solar power plants not only must the system for mounting photovoltaic panels be secure and rugged, but the system must also be relatively easy and quick to install.

There is a need for an improved assembly for mounting a photovoltaic module.

### SUMMARY OF THE DISCLOSURE

According to an aspect of the present disclosure, a saddle bracket assembly comprises a saddle bracket fastened to a saddle bracket support with a plurality of rivets. The saddle bracket includes a saddle bracket web and first and second opposing flanged sidewalls separated by the saddle bracket web, where each of the first and second opposing flanged sidewalls includes a saddle bracket rivet hole. The saddle bracket support includes a bracket support web and first and second bracket support opposing sidewalls separated by the bracket support web, and third and fourth bracket support opposing sidewalls separated by the bracket support web. Each of the first and second bracket support opposing sidewalls are substantially orthogonal to the third and fourth bracket support opposing sidewalls, and where each of the first and second bracket support opposing sidewalls includes a respective bracket support rivet hole on each of its longitudinal ends and where each of the third and fourth bracket support opposing sidewalls includes a bracket support rivet hole. The saddle bracket web rests on the bracket support web with each of the saddle bracket rivet holes coaxially aligned with an associated one of the respective bracket support rivet holes and the coaxially aligned holes include one of a plurality of rivets to provide rivet joints that fasten the bracket support to the saddle bracket.

The saddle bracket may be a first unitary component and the bracket support may be a second unitary component.

Each of the first and second opposing flanged sidewalls may include first and second flanges comprising flange rivet holes.

Each of the saddle bracket support rivet holes may be coaxially aligned with an associated one of the flange rivet holes and each receives a second rivet to fasten the bracket support to the saddle bracket.

The saddle bracket web and the bracket support web may be foraminated.

The saddle bracket web and the bracket support web may each include a plurality of fastener openings.

Each of the first and second opposing flanged sidewalls may further comprise a plurality of bracket mounting holes for mounting the saddle bracket assembly to a post.

The saddle bracket web and the bracket support web may each include a plurality of fastener openings for attaching a bearing assembly to the saddle bracket assembly with fasteners.

Each of the first and second opposing flanged sidewalls may include radiused segments between each of the first and second opposing flanged sidewalls and the bracket web.

According to another aspect of the present disclosure, a saddle bracket assembly comprises a saddle bracket comprising a saddle bracket web and first and second opposing flanged sidewalls separated by the saddle bracket web, where each of the first and second opposing flanged sidewalls includes a saddle bracket fastener hole. The assembly also includes a saddle bracket support comprising a bracket support web and first and second bracket support opposing sidewalls separated by the bracket support web, and third and fourth bracket support opposing sidewalls separated by the bracket support web, where each of the first and second bracket support opposing sidewalls are substantially orthogonal to the third and fourth bracket support opposing sidewalls, and where each of the first and second bracket support opposing sidewalls includes a respective bracket support fastener hole on each of its longitudinal ends and where each of the third and fourth bracket support opposing sidewalls includes a bracket support fastener hole. The saddle bracket web rests on the bracket support web with each of the saddle bracket support fastener holes coaxially aligned with an associated one of the flange fastener holes and each receives a fastener to fasten the bracket support to the saddle bracket.

Each of the saddle bracket fastener holes may be coaxially aligned with an associated one of the respective bracket support fastener holes and includes one of a plurality of second fasteners to fasten the bracket support to the saddle bracket.

The fasteners and second fasteners may comprise rivets.

The fasteners and second fasteners may comprise pins.

The fasteners and second fasteners may comprise self tapping screws.

Each of the first and second opposing flanged sidewalls may include radiused segments between each of the first and second opposing flanged sidewalls and the bracket web, and second radiused edge transitions between each of the first and second opposing flanged sidewalls and flanges may extend therefrom.

The foregoing features and the operation of the invention will become more apparent in light of the following description and the accompanying drawings.

### BRIEF DESCRIPTION OF THE DRAWINGS

FIG. 1 is a perspective view of a saddle bracket;

FIG. 2 is a top view of the saddle bracket of FIG. 1;

FIG. 3 is a side view of the saddle bracket of FIGS. 1 and 2;

FIG. 4 is a flat view of the saddle bracket of FIGS. 1-3;

FIG. 5 is a first perspective view of a saddle bracket support;

FIG. 6 is a second perspective view of the saddle bracket support of FIG. 5;

FIG. 7 is a flat view of the saddle bracket support of FIGS. 5-6;

FIG. 8 is a first perspective view of a saddle bracket assembly that includes the saddle bracket of FIGS. 1-4 fastened to the saddle bracket support of FIGS. 5-7;

FIG. 9 is a second perspective view of the saddle bracket assembly of FIG. 8; and

FIG. 10 is a side view of the saddle bracket assembly of FIGS. 8-9.

### DETAILED DESCRIPTION

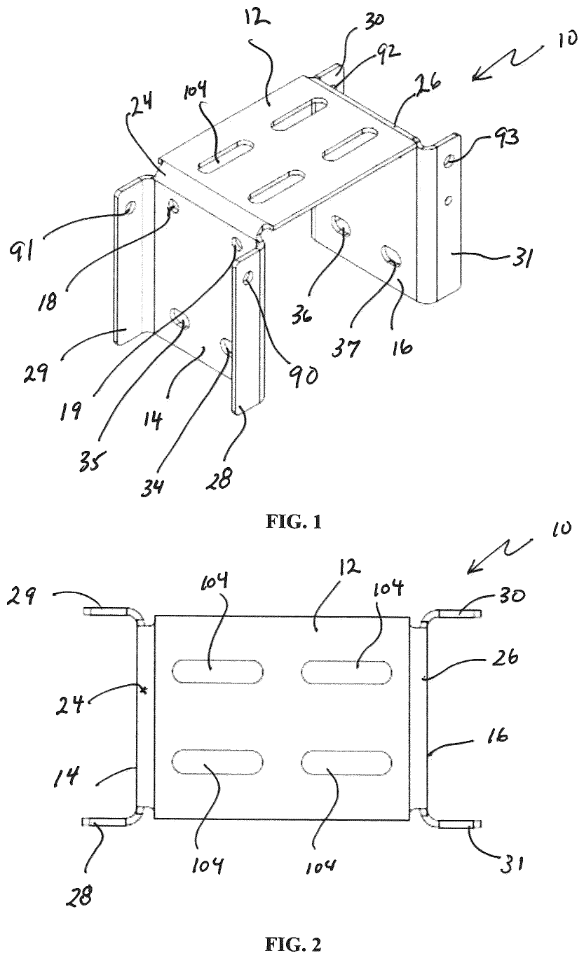

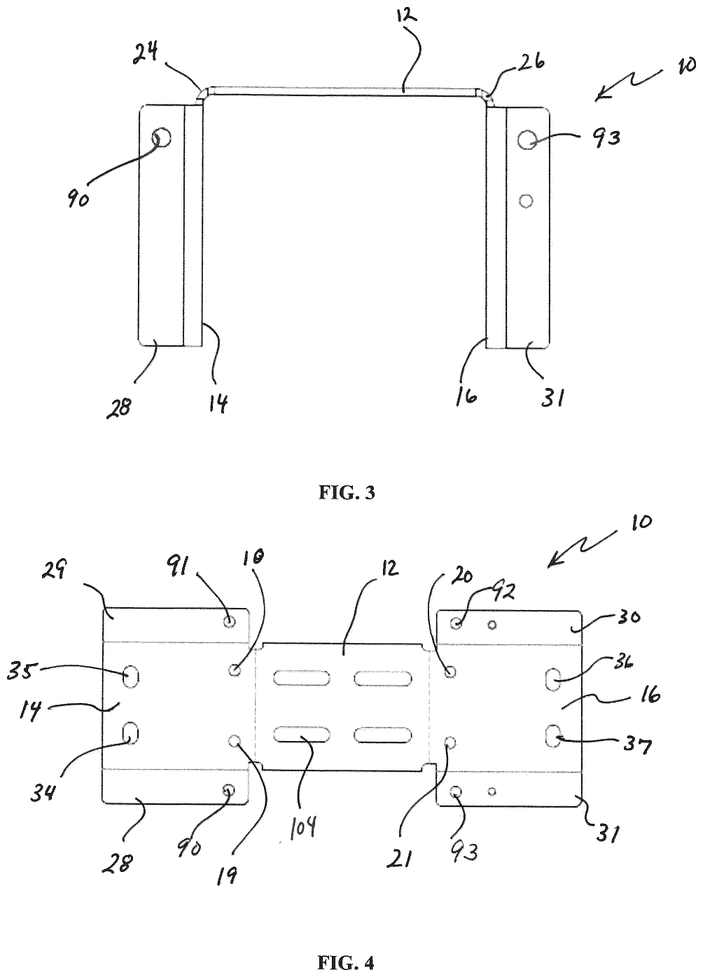

FIG. 1 is a perspective view of a saddle bracket 10. FIG. 2 is a top view of the saddle bracket 10 of FIG. 1. FIG. 3 is a side view of the saddle bracket 10 and FIG. 4 is a flat view of the saddle bracket 10. Referring to FIGS. 1-4, the saddle bracket 10 includes a saddle bracket web 12 and first and second opposing flanged sidewalls 14, 16 separated by the saddle bracket web. Each of the first and second opposing flanged sidewalls 14, 16 includes at least one saddle bracket rivet hole, e.g., holes 18-21. The surface transition between the web and the first and second opposing flanged sidewalls 14, 16 may include radiused segments 24, 26.

The first and second opposing flanged sidewalls 14, 16 each include first and second flanges 28-31. The saddle bracket web 12 is foraminated with a plurality of fastener openings 104. Each of the first and second opposing flanged sidewalls 14, 16 also includes a plurality of bracket mounting holes 34-37 for fastening the saddle bracket to a post (not shown). For example, with a fastener such a threaded nut and bolt. Radiused edge transitions are located between each of the first and second opposing flanged sidewalls (14, 16) and its respective flanges (28-31) extending therefrom.

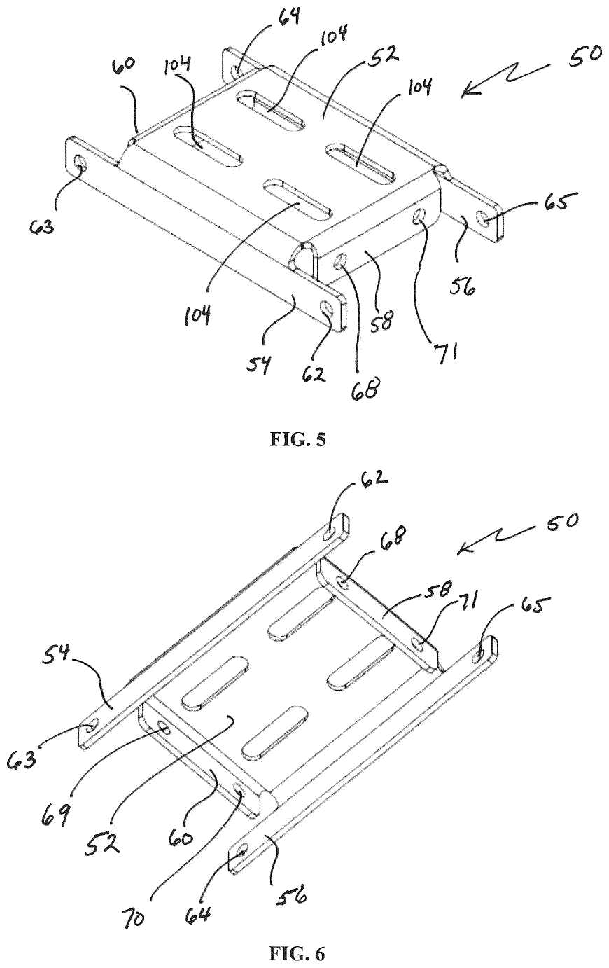

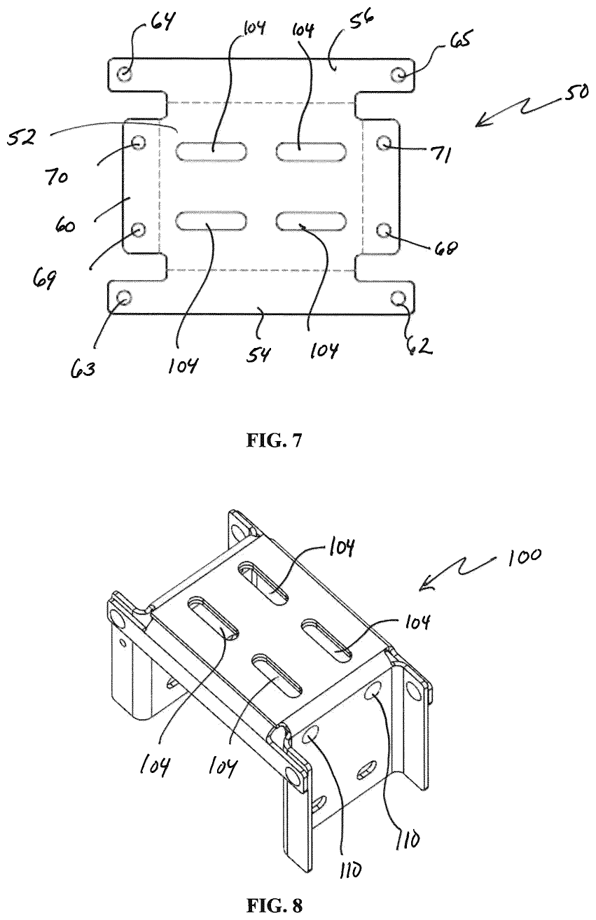

FIG. 5 is a first perspective view of a saddle bracket support 50. FIG. 6 is a second perspective view of the saddle bracket support 50 of FIG. 5. FIG. 7 is a flat view of the saddle bracket support of FIGS. 5-6. Referring to FIGS. 5-7, the bracket support includes a bracket support web 52 and first and second bracket support opposing sidewalls 54, 56 separated by the web 52. The first and second bracket support opposing sidewalls 54, 56 may also be referred to as skirt plates or side plates. The bracket support 50 also includes third and fourth bracket support opposing sidewalls 58, 60 separated by the web 52, where each of the first and second bracket support opposing sidewalls 54, 56 are substantially orthogonal to the third and fourth bracket support opposing sidewalls 58, 60. Each of the first and second bracket support opposing sidewalls 54, 56 includes a respective support rivet hole 62-65 on each of its longitudinal ends. Each of the third and fourth bracket support opposing sidewalls 58, 60 includes bracket support rivet holes 68-71.

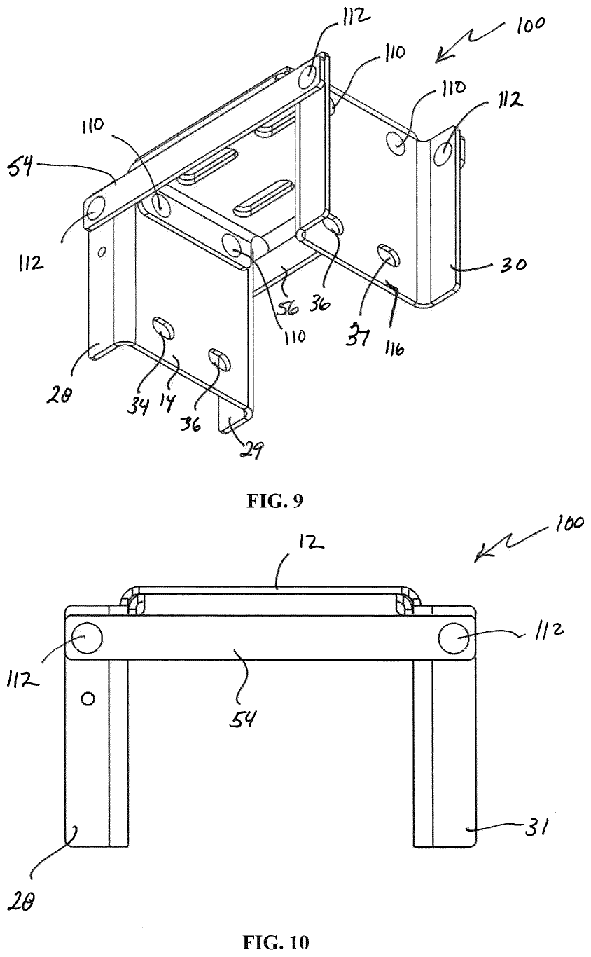

FIG. 8 is a first perspective view of a saddle bracket assembly 100 that includes the saddle bracket 10 of FIGS. 1-4 fastened to the saddle bracket support 50 of FIGS. 5-7. FIG. 9 is a second perspective view of the saddle bracket assembly 100 and FIG. 10 is a side view of the saddle bracket assembly. Referring to FIGS. 8-10, the saddle bracket web 12 rests on the bracket support web 52, with each of the saddle bracket rivet holes 18-21 coaxially aligned with an associated one of the bracket support rivet holes 68-71. Each of the coaxially aligned saddle bracket rivet holes 18-21 and the bracket support rivet holes 68-71 includes one of a plurality of first rivets to provide rivet joints that fasten the bracket support 50 to the saddle bracket 10 to form the saddle bracket assembly 100. As a result, in this embodiment there are four first rivets. However, one of ordinary skill will appreciate there can be fewer or more than the four coaxially aligned holes that receive the first rivets in this embodiment.

The bracket support and the saddle bracket that may also be attached by second rivets extending substantially orthogonal the first rivets. Referring to FIGS. 1-4, the saddle bracket 10 has at least one of a plurality of flange rivet holes 90-93 (FIGS. 1-4) on each of the first and second flanges 28-31 (FIGS. 1-4). The flange rivet holes 90-93 align with an associated one of the support rivet holes 62-65 (FIGS. 5-7) of the bracket support 50. Each of the coaxially aligned flange rivet holes 90-93 and the support rivet holes 62-65 includes one of a plurality of second rivets (not shown) to provide rivet joints that fasten the bracket support 50 to the saddle bracket 10.

The saddle bracket web 12 (FIGS. 1-4) and the bracket support web 62 (FIGS. 5-7) each include a plurality of aligned fastener openings 104 for attaching a bearing assembly (not shown) to the saddle bracket assembly (e.g., via a fastener such as a threaded nut and bolt).

The first and second rivets fastening the saddle bracket 10 to the bracket support 50 may be installed in a manufacturing setting, making it easier to use jigs and fixtures to properly position the bracket and bracket support so the rivets are oriented properly. However, it is contemplated that the bracket and bracket support may be fastened together in the field.

The bracket assembly and the bracket support may each be formed from cold formed steel.

Rather than rivets it is contemplated that other types of fasteners may be used, such as for examples nuts and bolts, self tapping screw, pin, etc. One of the features of the bracket assembly is that it utilizes fasteners, such rivets or nuts and bolts to secure the saddle bracket to the bracket support, rather than welding or brazing these components to form the assembly. This improves the resistance of the assembly to low cycle fatigue.

The saddle bracket allows an installer to quickly, safely and easily secure a PV module to a support structure.

Although the subject matter has been described in language specific to structural features or methodological acts, it is to be understood that the subject matter defined in the appended claims is not necessarily limited to the specific features and acts described above. Rather, the specific features and acts described above are disclosed as example forms of implementing at least one of the claims.

Various operations of embodiments are provided herein. The order in which some or all of the operations described should not be construed to imply that these operations are necessarily order dependent. Alternatively ordering will be appreciated having the benefit of this description. Further it will be understood that not all operations are necessarily present in each embodiment provided herein. Also it will be understood that not all operations are necessary in some embodiments.

Many modifications may be made to the current invention without departing from the scope or spirit of the claimed subject matter. Unless specified otherwise, “first,” “second,” or the like are not intended to imply a temporal aspect, a spatial aspect, an ordering etc. Rather such terms are merely used as identifiers names etc. for features, elements, items etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alternations and modifications will occur to others skilled in the art based upon reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe the components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one or several implementations, such feature may be combined with one or more other features of the other implementations as may be desired and advantageous for any given or particular application.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A saddle bracket assembly, comprising:
a saddle bracket comprising a saddle bracket web and first and second opposing flanged sidewalls separated by the saddle bracket web, where each of the first and second opposing flanged sidewalls includes a saddle bracket rivet hole; and
a saddle bracket support comprising a bracket support web and first and second bracket support opposing sidewalls separated by the bracket support web, and third and fourth bracket support opposing sidewalls separated by the bracket support web, where each of the first and second bracket support opposing sidewalls are substantially orthogonal to the third and fourth bracket support opposing sidewalls, and where each of the first and second bracket support opposing sidewalls includes a respective bracket support rivet hole on each of its longitudinal ends and where each of the third and fourth bracket support opposing sidewalls includes a bracket support rivet hole;
where the saddle bracket web rests on the bracket support web with each of the saddle bracket rivet holes coaxially aligned with an associated one of the respective bracket support rivet holes and includes one of a plurality of rivets to provide rivet joints that fasten the bracket support to the saddle bracket.

2. The saddle bracket assembly of claim 1, where the saddle bracket is a first unitary component and the bracket support is a second unitary component.

3. The saddle bracket assembly of claim 2, where each of the first and second opposing flanged sidewalls each include first and second flanges comprising flange rivet holes.

4. The saddle bracket assembly of claim 3, where each of the saddle bracket support rivet holes is coaxially aligned with an associated one of the flange rivet holes and each receives a second rivet to fasten the bracket support to the saddle bracket.

5. The saddle bracket assembly of claim 4, where the saddle bracket web and the bracket support web are foraminated.

6. The saddle bracket assembly of claim 5, where the saddle bracket web and the bracket support web each include a plurality of fastener openings.

7. The saddle bracket assembly of claim 4, where each of the first and second opposing flanged sidewalls further comprises a plurality of bracket mounting holes for mounting the saddle bracket assembly to a post.

8. The saddle bracket assembly of claim 4, where the saddle bracket web and the bracket support web each include a plurality of fastener openings for attaching a bearing assembly to the saddle bracket assembly with fasteners.

9. The bracket assembly of claim 1, where each of the first and second opposing flanged sidewalls includes radiused segments between each of the first and second opposing flanged sidewalls and the bracket web.

10. A saddle bracket assembly, comprising:
a saddle bracket comprising a saddle bracket web and first and second opposing flanged sidewalls separated by the saddle bracket web, where each of the first and second opposing flanged sidewalls includes a saddle bracket fastener hole; and
a saddle bracket support comprising a bracket support web and first and second bracket support opposing sidewalls separated by the bracket support web, and third and fourth bracket support opposing sidewalls separated by the bracket support web, where each of the first and second bracket support opposing sidewalls are substantially orthogonal to the third and fourth bracket support opposing sidewalls, and where each of the first and second bracket support opposing sidewalls includes a respective bracket support fastener hole on each of its longitudinal ends and where each of the third and fourth bracket support opposing sidewalls includes a bracket support fastener hole;
where the saddle bracket web rests on the bracket support web with each of the saddle bracket support fastener holes is coaxially aligned with an associated one of the flange fastener holes and each receives a fastener to fasten the bracket support to the saddle bracket.

11. The saddle bracket assembly of claim 10, where each of the saddle bracket fastener holes is coaxially aligned with an associated one of the respective bracket support fastener holes and includes one of a plurality of second fasteners to fasten the bracket support to the saddle bracket.

12. The saddle bracket assembly of claim 10, where the fasteners and second fasteners comprise rivets.

13. The saddle bracket assembly of claim 11, where each of the first and second opposing flanged sidewalls includes radiused segments between each of the first and second opposing flanged sidewalls and the bracket web, and second radiused edge transitions between each of the first and second opposing flanged sidewalls and flanges extending therefrom.

14. The saddle bracket assembly of claim 10, where the fasteners and second fasteners comprise pins.

15. The saddle bracket assembly of claim 10, where the fasteners and second fasteners comprise self tapping screws.
